(19) United States
(12) Patent Application Publication
(10) Pub. No.: US 2026/0296940 A1
(43) Pub. Date: Oct. 1, 2026

(54) ICE MAKER APPLIANCE SCALE CARTRIDGE

(71) Applicant: Haier US Appliance Solutions, Inc., Wilmington, DE (US)

(72) Inventors: Gregory Sergeevich Chernov, Louisville, KY (US); Samuel Vincent DePlessis, Louisville, KY (US)

(21) Appl. No.: 19/090,492

(22) Filed: Mar. 26, 2025

(51) Int. Cl. C02F 5/06; F25C 1/147; F25C 1/25

(52) U.S. Cl. CPC C02F 5/06; F25C 1/25; C02F 2201/006; C02F 2307/12; F25C 1/147; F25C 2400/14

(57) ABSTRACT

An ice maker appliance includes a casing. An ice maker and a pump are disposed within the casing. The pump is operable to flow water from a water supply to the ice maker. Additionally, the appliance includes a thermal scale precipitator cartridge. A volume of the cartridge is in fluid communication with the water supply and the ice maker. The cartridge includes a nucleation surface that is contacted by water that flows within and through the volume of the TSP cartridge. The nucleation surface is a surface upon which minerals within the water are deposited for restraining the minerals within the cartridge.

### FIELD

The present subject matter relates generally to ice maker appliances, and more particularly to ice maker appliances that recirculate water.

### BACKGROUND

Ice makers generally produce ice for use by consumers, such as in beverages, for cooling food items, etc. Certain refrigerator appliances include ice makers for producing ice. The ice maker can be positioned within the appliance's freezer chamber and direct ice into an ice bucket where the ice is stored within the freezer chamber. Such refrigerator appliances can also include a dispensing system for assisting a user with accessing ice produced by the refrigerator appliance's ice maker. However, the incorporation of ice makers into refrigerator appliances can have drawbacks, such as limits on the amount of ice that can be produced and the reliance on the refrigeration system of the refrigerator appliance to form the ice.

Recently, stand-alone ice makers have been developed. These ice makers are separate from refrigerator appliances and provide independent ice supplies. Generally, liquid water is added to the stand-alone ice makers, and the ice makers operate to freeze the liquid water and form ice. Users frequently add tap water to the stand-alone ice makers. Tap water may include various impurities, such as minerals, e.g., calcium or magnesium, which may also be referred to as hard water. Tap water containing high concentrations of such minerals, e.g., hard tap water, may negatively affect the appearance and/or taste of ice cubes formed from the tap water or may negatively affect the operation of the ice maker appliance, such as due to mineral deposits, scale, or other accumulations in or on components of the ice maker appliance.

Accordingly, improved ice makers are desired in the art. In particular, ice makers that address several of the above issues would be advantageous.

### BRIEF DESCRIPTION

Aspects and advantages of the present disclosure will be set forth in part in the following description, or may be apparent from the description, or may be learned through practice of the invention.

In one exemplary aspect of the present disclosure, an ice maker appliance defining a vertical direction, a lateral direction, and a transverse direction is provided. The ice maker appliance includes a casing. Additionally, the ice maker appliance includes an ice maker. The ice maker is disposed within the casing. Furthermore, the ice maker appliance includes a pump. The pump is disposed within the casing. Moreover, the pump is operable to flow water from a water supply to the ice maker. Additionally, the ice maker appliance includes a thermal scale precipitator (TSP) cartridge. A volume of the TSP cartridge is in fluid communication with the water supply and the ice maker. The TSP cartridge is positioned between the water supply and the ice maker such that water from the water supply flows within and through the volume of the TSP cartridge prior to flowing to the ice maker. Furthermore, the TSP cartridge includes a nucleation surface that is contacted by the water. The nucleation surface is a surface upon which minerals within the water are deposited for restraining the minerals within the TSP cartridge. Moreover, the ice maker appliance includes a heating element. The heating element is in thermal communication with the TSP cartridge. The heating element is activatable to heat the nucleation surface to facilitate deposition of the minerals on the nucleation surface.

In another exemplary aspect of the present disclosure, an ice maker appliance defining a vertical direction, a lateral direction, and a transverse direction is provided. The ice maker appliance includes a casing. Additionally, the ice maker appliance includes an ice maker. The ice maker is disposed within the casing. Furthermore, the ice maker appliance includes a pump. The pump is disposed within the casing. Moreover, the pump is operable to flow water from a water supply to the ice maker. Additionally, the ice maker appliance includes a thermal scale precipitator (TSP) cartridge. A volume of the TSP cartridge is in fluid communication with the water supply and the ice maker. Furthermore, the TSP cartridge includes a nucleation surface that is contacted by water that flows within and through the volume of the TSP cartridge. The nucleation surface is a surface upon which minerals within the water are deposited for restraining the minerals within the TSP cartridge.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a standalone ice maker appliance according to one or more example embodiments of the present disclosure.

FIG. 2 provides a perspective section view of the example appliance of FIG. 1.

FIG. 3 provides a rear perspective view of the example appliance of FIG. 1 with a casing of the example appliance removed to show interior components of the example appliance.

FIG. 4 provides a perspective view of the example appliance of FIG. 1 with a casing of the example appliance removed to show interior components of the example appliance.

FIG. 5 provides a cross-sectional view of an example thermal scale precipitator cartridge positioned within the example appliance of FIG. 1 according to one or more example embodiments of the present disclosure.

The use of the same reference numbers in the figures denotes the same or similar features unless the context indicates otherwise.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

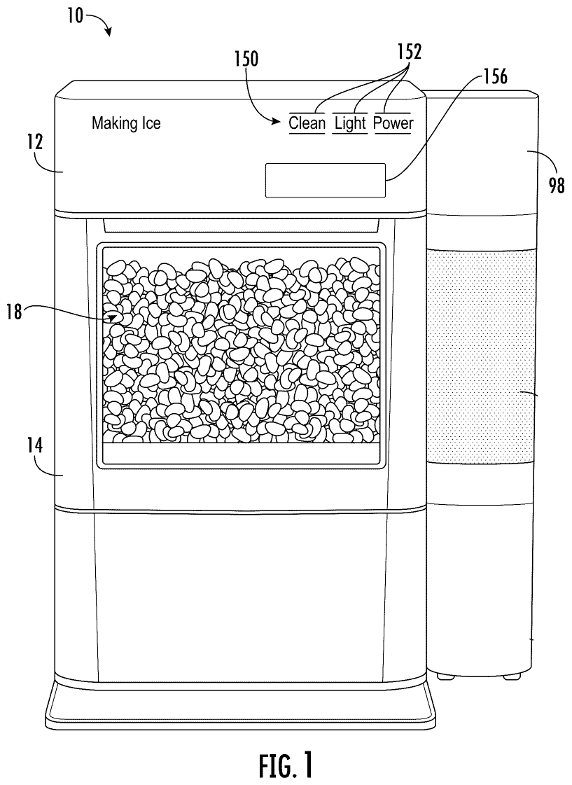

Referring now to FIGS. 1 through 3, one embodiment of an appliance 10 in accordance with the present disclosure is illustrated. As shown, appliance 10 is provided as a stand-alone ice maker appliance embodiment. Appliance 10 includes an outer casing 12 which defines a primary opening 11 (e.g., first primary opening) and an internal cavity or internal volume 13. Internal volume 13 generally at least partially houses various other components of the appliance 10 therein. Primary opening 11 defined in outer casing 12 may extend internal volume 13 to an ambient environment. Through primary opening 11, access (e.g., by a user) to at least a portion of the internal volume 13, which is defined by the outer casing 12, may be permitted. For example, through primary opening 11, a user may access an interior or storage volume, e.g., second storage volume 26, of a water tank 24 described below. Second storage volume 26 may be at least a portion of internal volume 13. Outer casing 12 further defines a vertical direction V, a lateral direction L, and a transverse direction T. The vertical direction V, lateral direction L, and transverse direction T are mutually perpendicular and form an orthogonal direction system.

A container 14 of appliance 10 is also illustrated. Container 14 defines a first storage volume 16 for the receipt and storage of ice 18 therein. A user of the appliance 10 may access ice 18 within the container 14 for consumption or other uses, as described in more detail below. Container 14 may include multiple walls, including one or more sidewalls 20 and a base wall 22, which may together define the first storage volume 16. In exemplary embodiments, at least one sidewall 20 may be formed in part from a clear, see-through (i.e., transparent or translucent) material, such as a clear glass or plastic, such that a user can see into the first storage volume 16 and thus view ice 18 therein. For instance, at least one sidewall 20 may include a separate external panel and internal panel formed from a clear, see-through (i.e., transparent or translucent) material, such as a clear glass or plastic. Further, in exemplary embodiments, container 14 may be removable, such as from the outer casing 12, by a user, and may expose primary opening 11. This facilitates advantageous easy access by the user to ice within the container 14, as discussed below and easy access by the user to at least a portion of the internal volume 13, such as to the second storage volume 26 of water tank 24.

In some embodiments, appliances 10 in accordance with the present disclosure are connected to plumbing or another water source that is external to the appliance 10, such as directly to water piping in a residence or other building. Additionally, or alternatively, in some embodiments, water is initially supplied to the appliance 10 manually by a user, such as by pouring water into water tank 24 and/or an auxiliary reservoir 98. Optionally, in some embodiments, water tank 24 may be removable, such as from the outer casing 12, by a user. This facilitates easy access by the user to water tank 24 (e.g., in order to easily fill water tank 24).

As discussed herein, appliance 10 is configured to make nugget ice. Ice 18 may be nugget ice. Generally, nugget ice is ice that that is maintained or stored (i.e., in first storage volume 16 of container 14) at a temperature greater than the melting point of water or greater than about thirty-two degrees Fahrenheit. Accordingly, the ambient temperature of the environment surrounding the container 14 may be at a temperature greater than the melting point of water or greater than about thirty-two degrees Fahrenheit. In some embodiments, such temperature may be greater than forty degrees Fahrenheit, greater than fifty degrees Fahrenheit, or greater than sixty degrees Fahrenheit.

Still referring to FIGS. 1 through 3, various components of appliance 10 in accordance with the present disclosure are illustrated. For example, as mentioned, appliance 10 includes water tank 24. The water tank 24 defines second storage volume 26 for the receipt and holding of liquid water. Water tank 24 may include multiple walls, including one or more sidewalls 28 and a base wall 30, which may together define the second storage volume 26. In exemplary embodiments, the water tank 24 may be disposed below the container 14 along the vertical direction V defined by the appliance 10, as shown.

As discussed, in exemplary embodiments, water is provided to the water tank 24 for use in forming ice. Accordingly, appliance 10 may further include a pump 32. Pump 32 may be in fluid communication with the second storage volume 26. For example, water may be flowable from the second storage volume 26 through a fluid outlet 31 defined in the water tank 24, such as in a sidewall 28 thereof, and may flow through a conduit to and through pump 32. Pump 32 may, when activated, actively flow water from the second storage volume 26 therethrough and from the pump 32.

Water actively flowed from the pump 32 may be flowed (e.g., through a suitable conduit) to a reservoir 34. For example, reservoir 34 may define a third storage volume 36. In some embodiments, third storage volume 36 is defined by one or more sidewalls 38 and a base wall 40. Third storage volume 36 may, for example, be in fluid communication with the pump 32 and may thus receive water that is actively flowed from the water tank 24, such as through the pump 32. During operation, water may be flowed into the third storage volume 36 through an opening 44 defined in the reservoir 34.

Reservoir 34 and third storage volume 36 thereof may receive and contain water to be provided to an ice maker 50 for the production of ice. Accordingly, third storage volume 36 may be in fluid communication with ice maker 50. For example, water may be flowed, such as through an opening 42 and through suitable conduits, from third storage volume 36 to ice maker 50.

Ice maker 50 generally receives water, such as from reservoir 34, and freezes the water to form ice 18. In exemplary embodiments, ice maker 50 is a nugget ice maker, and in particular is an auger-style ice maker, although other suitable styles of ice makers and/or appliances are within the scope and spirit of the present disclosure. As shown, ice maker 50 may include a casing 52 into which water from third storage volume 36 is flowed. Casing 52 is thus in fluid communication with third storage volume 36. For example, casing 52 may include one or more sidewalls 54 which may define an interior volume 56, and an opening may be defined in a sidewall 54. Water may be flowed from third storage volume 36 through the opening (such as via a suitable conduit) into the interior volume 56.

As illustrated, an auger 60 may be disposed at least partially within the casing 52. During operation, the auger 60 may rotate. Water within the casing 52 may at least partially freeze due to heat exchange, such as with a refrigeration system as discussed herein. The at least partially frozen water may be lifted by the auger 60 from casing 52. Further, in exemplary embodiments, the at least partially frozen water may be directed by auger 60 to and through an extruder 62. The extruder 62 may extrude the at least partially frozen water to form ice, such as nuggets of ice 18.

Formed ice 18 may be provided by the ice maker 50 to container 14 and may be received in the first storage volume 16 thereof. For example, ice 18 formed by auger 60 and/or extruder 62 may be provided to the container 14. In exemplary embodiments, appliance 10 may include a chute 70 for directing ice 18 produced by the ice maker 50 towards the first storage volume 16. For example, as shown, chute 70 is generally positioned above container 14 along the vertical direction V. Thus, ice can slide off of chute 70 and drop into first storage volume 16 of container 14. Chute 70 may, as shown, extend between ice maker 50 and container 14, and may include a body 72, which defines a passage 74 therethrough. Ice 18 may be directed from the ice maker 50 (such as from the auger 60 and/or extruder 62) through the passage 74 to the container 14. In some embodiments, for example, a sweep 64, which may be connected to and rotate with the auger, may contact the ice emerging through the extruder 62 from the auger 60 and direct the ice 18 through the passage 74 to the container 14.

As discussed, water within the casing 52 may at least partially freeze due to heat exchange, such as with a refrigeration system. In exemplary embodiments, ice maker 50 may include a sealed refrigeration system 80. The sealed refrigeration system 80 may be in thermal communication with the casing 52 to remove heat from the casing 52 and interior volume 56 thereof, thus facilitating freezing of water therein to form ice. Sealed refrigeration system 80 may, for example, include a compressor 82, a condenser 84, a throttling device 86, and an evaporator 88. Evaporator 88 may, for example, be in thermal communication with the casing 52 in order to remove heat from the interior volume 56 and water therein during operation of sealed refrigeration system 80. For example, evaporator 88 may at least partially surround the casing 52. In particular, evaporator 88 may be a conduit coiled around and in contact with casing 52, such as the sidewall(s) 54 thereof.

It should additionally be noted that, in some embodiments, a controller 200 may be in operative communication with the sealed refrigeration system 80, such as with the compressor 82 thereof, and may activate the sealed refrigeration system 80 as desired or required for ice making purposes.

In some embodiments, controller 200 is in operative communication with the pump 32. Such operative communication may be via a wired or wireless connection and may facilitate the transmittal and/or receipt of signals by the controller 200 and pump 32. Controller 200 may be configured to activate the pump 32 to actively flow water. For example, controller 200 may activate the pump 32 to actively flow water therethrough when, for example, reservoir 34 requires water. A suitable sensor(s), for example, may be provided in the third storage volume 36. The sensor(s) may be in operative communication with the controller 200 and may be configured to transmit signals to the controller 200, which indicate whether or not additional water is desired in the reservoir 34. When controller 200 receives a signal that water is desired, controller 200 may send a signal to pump 32 to activate pump 32.

A control panel 150 is provided for controlling the mode of operation. For example, control panel 150 includes one or more selector inputs 152, such as knobs, buttons, touchscreen interfaces, etc., such as an ice-dispensing button, for selecting a desired mode of operation such as cleaning mode or ice making mode ice. Selector inputs 152 may be in communication with controller 200. Signals generated in controller 200 operate appliance 10 in response to selector inputs 152. Additionally, a display 156, such as an indicator light or a screen, may be provided on control panel 150. The display 156 may be in communication with controller 200, and may display information in response to signals from controller 200.

As used herein, “processing device” or “controller” may refer to one or more microprocessors or semiconductor devices and is not restricted necessarily to a single element. The processing device can be programmed to operate appliance 10. The processing device may include, or be associated with, one or more memory elements (e.g., non-transitory storage media). In some such embodiments, the memory elements include electrically erasable, programmable read only memory (EEPROM). Generally, the memory elements can store information accessible to the processing device, including instructions that can be executed by processing device. Optionally, the instructions can be software or any set of instructions and/or data that when executed by the processing device, cause the processing device to perform operations.

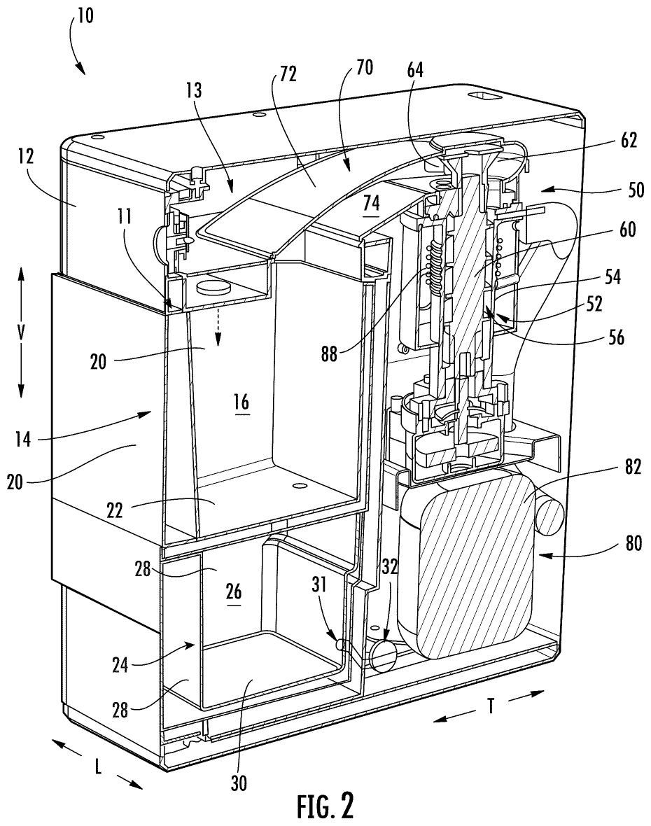

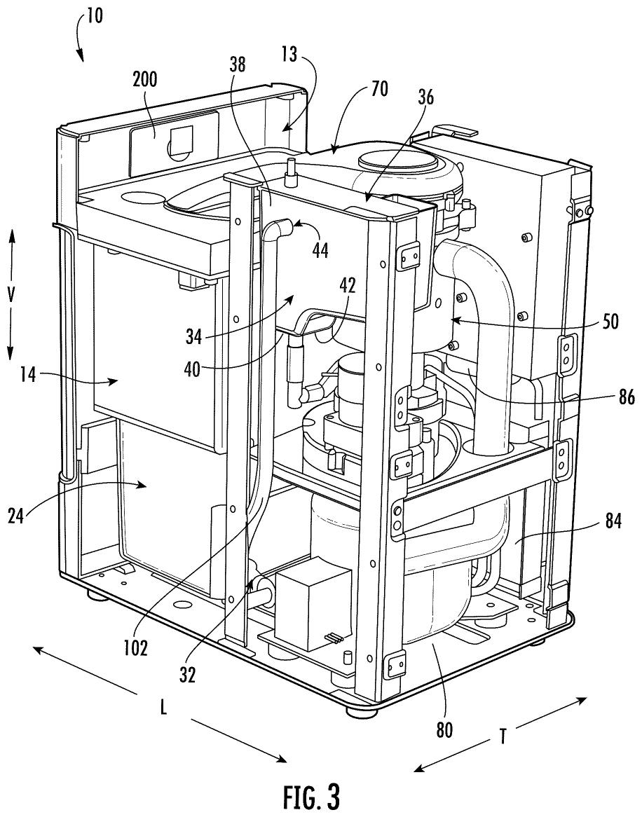

As briefly described above, appliance 10 may include a water conduit or line 102. Water line 102 may be one or more pipes, tubes, and/or the like, which provide a pathway for water to flow within and/or from water tank 24 and to ice maker 50. For example, as illustrated in FIG. 2, in some embodiments, water line 102 may be at least partially positioned within water tank 24. Water line 102 may be in fluid communication with second storage volume 26. Additionally, as best illustrated in FIG. 3, water line 102 may extend externally of water tank 24, such as between second storage volume 26 and third storage volume 36. Pump 32 may be in fluid communication with water line 102 and, thus, pump the water through water line 102 from second storage volume 26 to third storage volume 36.

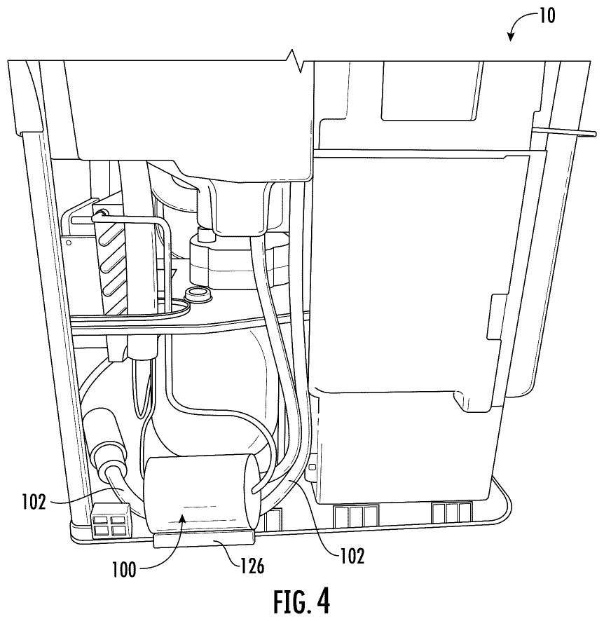

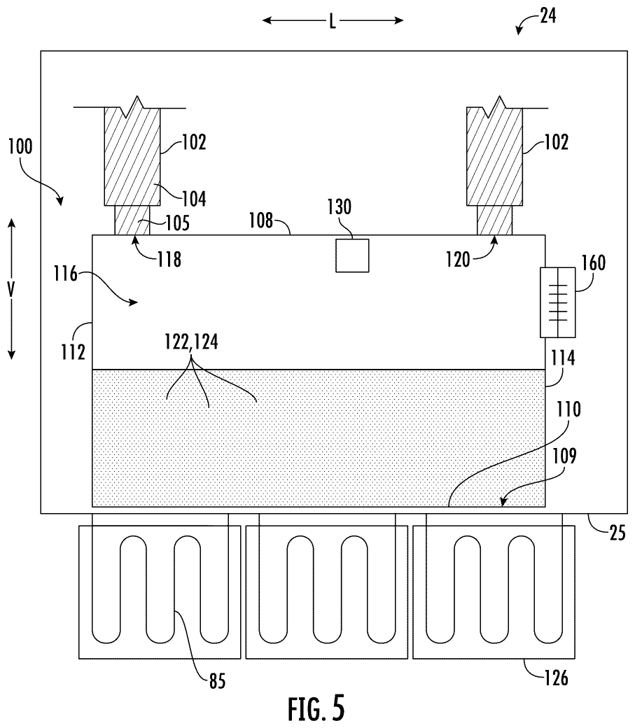

Referring now to FIGS. 4 and 5, various views are provided that illustrate a thermal scale precipitator (TSP) cartridge 100 within the appliance 10. Specifically, FIG. 4 provides a perspective view of the appliance 10 with the outer casing 12 of the appliance 10 removed to expose interior components of the appliance 10. In particular, FIG. 4 illustrates the TSP cartridge 100 provided within the outer casing 12 of the appliance 10. FIG. 5 provides a cross-sectional view of the TSP cartridge 100 positioned within the appliance 10. In exemplary embodiments, appliance 10 includes the TSP cartridge 100. TSP cartridge 100 may be positioned within outer casing 12, e.g., within water tank 24 as illustrated in FIG. 5. However, while shown in FIG. 5 as positioned within water tank 24, it should be appreciated that TSP cartridge 100 may also be positioned partially or entirely externally of water tank 24. As described herein, TSP cartridge 100 may be utilized for softening water in appliance 10. By softening water in appliance 10, impurities, e.g., minerals such as calcium or magnesium, that cause scaling within the appliance 10, negatively affect the appearance and/or taste of ice formed by ice maker 50, and/or that otherwise have a deleterious impact on the appliance 10 may be removed from the water. Thus, the performance of the ice maker appliance, such as the quality of ice produced, operability of the appliance without cleaning, and length of time between cleanings, may be improved.

As illustrated in FIG. 5, TSP cartridge 100 may include a top wall 108 and a bottom wall 110 spaced apart from each other, e.g., in the vertical direction V. Additionally, TSP cartridge 100 may include a first (left) side wall 112 and a second (right) side wall 114 spaced laterally apart from each other, e.g., in the lateral direction L. Top wall 108, bottom wall 110, first side wall 112, and second side wall 114 may collectively define an internal volume 116 of TSP cartridge 100. The walls 108, 110, 112, and 114 of TSP cartridge 100 may collectively define a main body or structure of the TSP cartridge 100 that, in some embodiments, may be cylindrically shaped. However, it should be appreciated that the main body or structure of the TSP cartridge 100 may also be any other suitable shape, such as rectangular.

Additionally, internal volume 116 of TSP cartridge 100 may be in fluid communication with a water supply and with ice maker 50. As such, TSP cartridge 100 may be positioned along water line 102 between a water supply, e.g., water tank 24, and ice maker 50. In this respect, as illustrated in FIGS. 4 and 5, TSP cartridge 100 may include a water inlet 118, which may be an aperture defined through one of the walls, e.g., top wall 108, and a water outlet 120, which may also be an aperture defined through one of the walls, e.g., top wall 108. Water inlet 118 may be in fluid communication with water from the water supply, e.g., water within water tank 24. In some embodiments, water inlet 118 is fluidly coupled to a portion of water line 102 that is upstream of TSP cartridge 100, and water line 102 may be fluidly coupled to second storage volume 26. As such, the water from the second storage volume 26 may flow from water line 102, e.g., pumped by pump 32, through water inlet 118 of TSP cartridge 100, and into internal volume 116 where, as will be described below, hard water ions of the water are separated out and restrained within TSP cartridge 100. Furthermore, in some embodiments, water outlet 120 is fluidly coupled to a portion of water line 102 downstream of TSP cartridge 100. As such, once hard water ions have been separated and restrained, the water within internal volume 116 of TSP cartridge 100, now containing little to no hard water ions, may flow, e.g., pumped by pump 32, out of TSP cartridge 100 through water outlet 120 and to reservoir 34. While described herein as being pumped by pump 32 through TSP cartridge 100, it should be appreciated that the water may flow naturally, e.g., gravity assisted, through internal volume 116 of TSP cartridge 100 without assistance from pump 32.

Moreover, in exemplary embodiments, one or more nucleation surfaces 122 are provided within internal volume 116 of TSP cartridge 100. The nucleation surface(s) 122 are surfaces in which hard water ions and minerals are deposited on and separated from the water flowing through internal volume 116 as described above. For example, in some embodiments, a plurality of water softening or seed media 124, such as limestone particles, may be positioned in internal volume 116 of TSP cartridge 100. Each of the seed media 124 may define a separate nucleation seed media surface 122. The nucleation seed media surface(s) 122 are contacted by the water as the water flows through internal volume 116. Once the hard water ions and minerals are separated from the water and deposited on nucleation seed media surface(s) 122, the hard water ions and minerals are restrained/contained within internal volume 116 and, thus, are inhibited or prevented from flowing out of TSP cartridge 100. As will be described below, nucleation seed media surface(s) 122 are heated to facilitate separation of the hard water ions and minerals from the water and deposition onto nucleation seed media surface(s) 122.

Furthermore, in exemplary embodiments, a heating element 126 is in thermal communication with TSP cartridge 100. The heating element 126 may be activatable to heat to nucleation seed media surface(s) 122, which facilitates separation of the hard water ions and minerals from the water flowing through internal volume 116 of TSP cartridge 100 and deposition onto nucleation seed media surface(s) 122. In this respect, as illustrated in FIG. 5 some or all of the seed media 124 may be distributed across an interior surface 109 of bottom wall 110 and directly contact or abut interior surface 109. Furthermore, each of the seed media 124 may be in direct contact with/touching a different one of the seed media 124, such that the plurality of seed media 124 are thermally connected. Additionally, heating element 126 may be positioned directly below bottom wall 110 of TSP cartridge 100. In some embodiments, heating element 126 may be entirely positioned externally of water tank 24, while TSP cartridge 100 is positioned entirely within water tank 24. In such embodiments, heating element 126 may abut a bottom wall 25 of water tank 24 externally of water tank 24. Likewise, bottom wall 110 of TSP cartridge 100 may abut bottom wall 25 within water tank 24. As such, bottom wall 25 of water tank 24 may be sandwiched between heating element 126 and bottom wall 110 of TSP cartridge 100. As such, during activation or operation of heating element 126, heat may pass through bottom wall 25 of water tank 24 and bottom wall 110 of TSP cartridge to heat the nucleation seed media surfaces 122 of the plurality of seed media 124. However, in some other embodiments, heating element 126 may directly abut bottom wall 110 of TSP cartridge 100.

Heating element 126 may heat nucleation seed media surface(s) 122 to a temperature range that includes a supersaturation temperature of the water within TSP cartridge 100. The supersaturation temperature is a temperature or temperature range at or within which scale formation occurs. The supersaturation temperature is a function of an initial temperature at which a solution, e.g., the water including the hard water ions/minerals, was dissolved, and how much solute, e.g., hard water ions/minerals, of the solution was dissolved at the initial temperature. Thus, the supersaturation temperature varies with the initial temperature and the composition of the solution. For example, in some embodiments, the supersaturation temperature range of hard water ions/minerals, e.g., calcium carbonate, may be between 240 degrees Fahrenheit and 500 degrees Fahrenheit. As such, as the water within internal volume 116 contacts and flows through or across the nucleation seed media surface(s) 122 heated to the supersaturation temperature, the hard water ions/minerals separate from the liquid water and become attached to the nucleation seed media surface(s) 122 and begin to crystallize. The softened water may then flow out of TSP cartridge 100 and utilized in the ice maker 50 to form ice pieces. While described herein as being heated to the supersaturation temperature of water, it should be appreciated that, heating element 126 may heat nucleation seed media surface(s) 122 to elevated temperatures below the boiling point of water of 212 degrees Fahrenheit to separate hard water ions/minerals from the liquid water and promote attachment of the separated hard water ions/minerals to nucleation seed media surface(s) 122. For example, in some embodiments, heating element 126 may heat nucleation seed media surface(s) 122 to temperatures between 120 degrees Fahrenheit and 200 degrees Fahrenheit. Heating the nucleation seed media surface(s) 122 to temperatures lower than the supersaturation temperatures permits the temperature within TSP cartridge 100 to be effectively cooled, such as by a heat sink as described below.

According to some exemplary embodiments, heating element 126 may be one or more condenser coils 85 of condenser 84 described above. Condenser coils 85 may receive and convey a flow of heated refrigerant or other fluid therethrough. The heated fluid within the condenser coils 85 may heat the condenser coils 85, which may pass by conduction through bottom wall 110 of TSP cartridge 100 and, thus, to the nucleation seed media surface(s) 122 described herein. Additionally, or alternatively, heating element 126 may be an outlet conduit 87 that is coupled between compressor 82 and condenser 84. The outlet conduit 87 may receive and convey a flow of heated refrigerant or other fluid therethrough from compressor 82 to condenser 84. The heated fluid within outlet conduit 87 may heat outlet conduit 87, which may pass by conduction through bottom wall 110 of TSP cartridge 100 and, thus, to the nucleation seed media surface(s) 122 described herein.

Furthermore, a heat sink 160 may be provided downstream of nucleation seed media surface(s) 122 and heating element 126, such as adjacent to water outlet 120, for decreasing the temperature of the water after the water contacts nucleation seed media surface(s) 122. The heat sink 160 may be any suitable heat dissipation component. For example, heat sink 160 may include a base (not shown) with a plurality of fins (not shown) and extend from the base for dissipating heat. As illustrated in FIG. 5, heat sink 160 is positioned on second side wall 114 externally of TSP cartridge 100 downstream of heating element 126 and adjacent to water outlet 120. Heat sink 160 is in thermal communication with the water downstream of nucleation seed media surface(s) 122 and heating element 126. As such, heat sink 160 may dissipate heat from the water that was heated by the heating element 126 as it passed through/across nucleation seed media surface(s) 122. Thus, heat sink 160 helps or ensures that the water falls below the supersaturation temperature range prior to exiting TSP cartridge 100 to minimize or prevent hard water ions and minerals from separating from the water externally of TSP cartridge 100.

Additionally, in some embodiments, TSP cartridge 100 may be removable from appliance 10 by a user for cleaning scale buildup with TSP cartridge 100 or for disposing TSP cartridge 100 and replacing with a new TSP cartridge 100. For example, TSP cartridge 100 or water line 102 may include a plurality of locking tabs 104, such as helical threads, which engage a plurality of corresponding slots 105 defined within the other of the TSP cartridge 100 or the water line 102. As such, as the locking tabs 104 engage the slots 105, the TSP cartridge 100 may be rotatable between an installed or coupled position and a decoupled position in which the TSP cartridge 100 is not attached to appliance 10. In the decoupled position, TSP cartridge 100 is entirely disengaged from water line 102 and, thus, is removable from water line 102. While described herein as being rotatable to couple and decouple TSP cartridge 100 from water line 102, it should be appreciated that TSP cartridge 100 may be removably coupled to water line 102 in any other suitable manner.

In some embodiments, a sensing device 130 may be provided in operative association with TSP cartridge 100. As described briefly above, hard water ions and minerals may be deposited on nucleation seed media surface(s) 122 and restrained within internal volume 116 even as the water exits TSP cartridge 100. As TSP cartridge 100 is utilized, scale buildup may occur due to the large number of hard water ions and minerals restrained within TSP cartridge 100. As such, sensing device 130 may generate data indicative of a hard water ion/mineral fill level of the hard water ions and minerals restrained within TSP cartridge 100. In some embodiments, sensing device 130 may be or may include ion-selective electrodes. As such, an electrical signal from the sensing device 130 may vary in response to a concentration of the hard water ions and minerals restrained within the TSP cartridge 100. For example, the sensing device 130 may measure or detect an electrical potential of the hard water ions and minerals, which may increase as the number of hard water ions and minerals that are restrained within the TSP cartridge 100 increase. However, it should be appreciated that sensing device 130 may be any suitable sensing device for generating data indicative of the hard water ion/mineral fill level of TSP cartridge 100.

Controller 200 may be operatively or communicatively coupled to sensing device 130. In this respect, controller 200 may receive the data indicative of the hard water ion/mineral fill level of TSP cartridge 100 generated by sensing device 130 and initiate a notification to a user of appliance 10 that that the TSP cartridge 100 if full of the hard water ions/minerals based on the data generated by the sensing device 130 and received by the controller 200. Specifically, utilizing the received data, controller 200 may determine the hard water ion/mineral fill level of TSP cartridge 100 and compare the determined fill level to a predetermined fill level threshold range. Thereafter, controller 200 may determine that cleaning of the scale buildup in TSP cartridge 100 or replacement of TSP cartridge 100 is needed. As such, controller 200 may initiate the notification to the user of appliance 10 that TSP cartridge 100 is full of hard water ions/minerals. For example, in some embodiments, controller 200 may initiate a notification on display 156, e.g., turning on an indicator light, which indicates that TSP cartridge 100 is full of hard water ions/minerals.

It should be appreciated that the appliance 10 described herein is a non-limiting example of an ice maker appliance. Changes in the configuration of the appliance 10 may be made while remaining within the scope of the present disclosure. Furthermore, the term “ice maker appliance” as defined herein is not limited to any particular type of ice maker appliance and may include any suitable type of appliance that circulates water. For example, the term “ice maker appliance” may include, but is not limited to, a refrigerator appliance that includes an ice maker, a standalone ice maker appliance such a tabletop ice maker appliance that produces nugget ice and/or any other type of ice, and/or the like. Additionally, the term “ice maker appliance” is not limited to appliances with fillable reservoirs and, thus, may include appliances directly fluidly connected to plumbing, e.g., of a residence.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An ice maker appliance defining a vertical direction, a lateral direction, and a transverse direction, the ice maker appliance comprising:
a casing;
an ice maker disposed within the casing;
a pump disposed within the casing, the pump operable to flow water from a water supply to the ice maker;
a thermal scale precipitator (TSP) cartridge, a volume of the TSP cartridge in fluid communication with the water supply and the ice maker, the TSP cartridge positioned between the water supply and the ice maker such that the water from the water supply flows within and through the volume of the TSP cartridge prior to flowing to the ice maker, the TSP cartridge comprising a nucleation surface contacted by the water, wherein the nucleation surface is a surface upon which minerals within the water are deposited thereon for restraining the minerals within the TSP cartridge; and
a heating element in thermal communication with the TSP cartridge, the heating element activatable to heat the nucleation surface to facilitate deposition of the minerals on the nucleation surface.

2. The ice maker appliance of claim 1, wherein:
the TSP cartridge comprises a top wall and a bottom wall spaced apart from each other in the vertical direction, the volume of the TSP cartridge at least partially defined between the top wall and the bottom wall;
a portion of the nucleation surface abuts an interior surface of the bottom wall; and
the bottom wall is positioned between the portion of the nucleation surface abutting the interior surface of the bottom wall and the heating element, the heating element in thermal communication with the nucleation surface through the bottom wall of the TSP cartridge for heating the nucleation surface.

3. The ice maker appliance of claim 1, wherein the nucleation surface comprises a plurality of seed media surfaces of a plurality of seed media.

4. The ice maker appliance of claim 3, wherein each seed media of the plurality of seed media is comprised at least partially of limestone.

5. The ice maker appliance of claim 1, further comprising:
a sensing device configured to generate data indicative of a mineral fill level of the minerals restrained within the TSP cartridge; and
a controller operatively coupled to the sensing device, the controller configured to initiate a notification to a user that the TSP cartridge is full of the minerals based on the data generated by the sensing device.

6. The ice maker appliance of claim 1, wherein the heating element comprises at least one of a coil of a condenser of the ice maker appliance or an outlet conduit coupled between the condenser and a compressor of the ice maker appliance, the coil of the condenser and the outlet conduit configured to receive a flow of heated fluid therethrough.

7. The ice maker appliance of claim 1, wherein:
a heat sink is in thermal communication with the water downstream of the nucleation surface of the TSP cartridge for decreasing a temperature of the water after the water contacts the nucleation surface.

8. The ice maker appliance of claim 1, wherein:
the ice maker appliance further comprises a water conduit positioned between the water supply and the ice maker;
the TSP cartridge is positioned along the water conduit between the water supply and the ice maker and is in fluid communication with the water conduit; and
the TSP cartridge is rotatable relative to the water conduit between a coupled position and a decoupled position, the TSP cartridge removable from the water conduit when in the decoupled position.

9. An ice maker appliance defining a vertical direction, a lateral direction, and a transverse direction, the ice maker appliance comprising:
a casing;
an ice maker disposed within the casing;
a pump disposed within the casing, the pump operable to flow water from a water supply to the ice maker; and
a thermal scale precipitator (TSP) cartridge, a volume of the TSP cartridge in fluid communication with the water supply and the ice maker, the TSP cartridge comprising a nucleation surface contacted by water that flows within and through the volume of the TSP cartridge, wherein the nucleation surface is a surface upon which minerals within the water are deposited thereon for restraining the minerals within the TSP cartridge.

10. The ice maker appliance of claim 9, further comprising:
a heating element in thermal communication with the TSP cartridge, the heating element activatable to heat the nucleation surface to facilitate deposition of the minerals on the nucleation surface.

11. The ice maker appliance of claim 10, wherein the heating element comprises at least one of a coil of a condenser of the ice maker appliance or an outlet conduit coupled between the condenser and a compressor of the ice maker appliance, the coil of the condenser and the outlet conduit configured to receive a flow of heated fluid therethrough.

12. The ice maker appliance of claim 10, wherein:
the TSP cartridge comprises a top wall and a bottom wall spaced apart from each other in the vertical direction, the volume of the TSP cartridge at least partially defined between the top wall and the bottom wall;
a portion of the nucleation surface abuts an interior surface of the bottom wall; and
the bottom wall is positioned between the portion of the nucleation surface abutting the interior surface of the bottom wall and the heating element, the heating element in thermal communication with the nucleation surface through the bottom wall of the TSP cartridge for heating the nucleation surface.

13. The ice maker appliance of claim 9, wherein the nucleation surface comprises a plurality of seed media surfaces of a plurality of seed media.

14. The ice maker appliance of claim 13, wherein each seed media of the plurality of seed media is comprised at least partially of limestone.

15. The ice maker appliance of claim 9, further comprising:
a sensing device configured to generate data indicative of a mineral fill level of the minerals restrained within the TSP cartridge; and
a controller operatively coupled to the sensing device, the controller configured to initiate a notification to a user that the TSP cartridge is full of the minerals based on the data generated by the sensing device.

16. The ice maker appliance of claim 9, wherein:
a heat sink is in thermal communication with the water downstream of the nucleation surface of the TSP cartridge for decreasing a temperature of the water after the water contacts the nucleation surface.

17. The ice maker appliance of claim 9, wherein:
the TSP cartridge is positioned between the water supply and the ice maker such that the water from the water supply flows within and through the volume of the TSP cartridge prior to flowing to the ice maker.

18. The ice maker appliance of claim 9, wherein:
the ice maker appliance further comprises a water conduit positioned between the water supply and the ice maker;
the TSP cartridge is positioned along the water conduit between the water supply and the ice maker and is in fluid communication with the water conduit; and
the TSP cartridge is rotatable relative to the water conduit between a coupled position and a decoupled position, the TSP cartridge removable from the water conduit when in the decoupled position.
